(19) United States
(12) Patent Application Publication
(10) Pub. No.: US 2006/0190323 A1
(43) Pub. Date: Aug. 24, 2006

(54) Consumer education and loyalty reward system

(75) Inventors: Jay Olson, Westfield, NJ (US); Daniel Best, Bay Village, OH (US); Michele Gallucci, New York, NY (US)

Correspondence Address: PFIZER INC, 150 EAST 42ND STREET, 5TH FLOOR - STOP 49, NEW YORK, NY, 10017-5612, US

(73) Assignee: Pfizer Inc

(21) Appl. No.: 11/064,162

(22) Filed: Feb. 23, 2005

(51) Int. Cl. G06Q 30/00

(52) U.S. Cl. 705/14

(57) ABSTRACT

A system and method for educating and rewarding a consumer of a prescribed pharmaceutical or intervention is provided. The system includes a means for enrolling the consumer in a consumer loyalty rewards program, a means for providing the consumer with information relating to the intervention, a means for tracking purchases of the intervention by the consumer, and a means for providing the consumer with a loyalty reward. The method comprises the steps of enrolling the consumer in a consumer loyalty rewards program, providing the consumer with information relating to the intervention, tracking the consumer's purchases of the intervention, issuing a reward after a prescribed number of purchases.

### BACKGROUND OF THE INVENTION

1. Field of the Invention

The present invention relates generally to a system and method for informing and rewarding loyal consumers. Particularly, the present invention relates to a system and method for informing and educating a prescription pharmaceutical consumer and rewarding the consumer loyalty, including tracking consumer purchasing activity for a prescribed pharmaceutical or therapeutic intervention.

2. Description of the Prior Art

Advertising and marketing are essential mechanisms by which companies provide product information to consumers. Consumer education is particularly important for pharmaceutical products. When a pharmaceutical consumer fails to receive sufficient information or perceives having less than sufficient information or has some degree of psychological discomfort about the taking or continued taking of a prescribed pharmaceutical or intervention, the consumer typically becomes anxious and concerned. The result of this anxiety or concern is commonly cessation of the prescribed treatment. Insufficient or reluctant communication with a prescribing physician or health care provider is another factor which commonly results in the discontinuance of a prescribed course of treatment.

Consumer education and psychological comfort are particularly important for pharmaceuticals and interventions used for the treatment of conditions such as erectile dysfunction. That is, where the consumer is concerned about continuing a course of treatment and the discontinuance of the treatment is not perceived as life-threatening, the consumer may elect to discontinue the treatment. Thus, while erectile dysfunction may likely adversely affect the psychological and emotional well-being, the unresolved anxiety or concern over the continued treatment may cause the consumer to discontinue purchasing the treatment. Often these unresolved concerns are compounded by the ongoing costs of continued treatment. The discontinuance rate for erectile dysfunction treatment is inordinately high. Viagra® (sildenfil citrate) is an example of one such prescribed pharmaceutical where patient consistency has been found to be undesirably low. Studies have shown that 66% of lapsed users of Viagra cite a perceived lack of effectiveness as a principal reason for ceasing treatment. However, such perceived ineffectiveness may likely be managed and assuaged through education including proper dosage and usage information. In fact, in a clinical study of lapsed Viagra® users, up to 50% of perceived non-responders did respond once provided with proper education. Moreover, 26% of lapsed users cite ongoing costs as a principal reason for ceasing treatment.

The treatment of erectile dysfunction is unique as compared with the treatment of a perceived life-threatening disorder, and is also unique in its highly personal, emotional and social ramifications. Where erectile dysfunction treatment includes the continued taking of a prescribed pharmaceutical, the individual may opt out of the continued purchase of the pharmaceutical because of unresolved concerns and questions, and the inability to readily address these concerns as well as the unavailability of sufficient user specific information. Consequently, the individual or user discontinues the taking of the prescribed pharmaceutical. Also, the partner of an erectile dysfunction sufferer plays an important role in the continuation of erectile dysfunction treatment. Patient education often helps address issues raised by partners of erectile dysfunction sufferers. User specific education is therefore necessary for erectile dysfunction treatment in order to ensure consumer loyalty. Advertising and marketing are integral tools for educating a pharmaceutical consumer and for promoting consumer loyalty, particularly a consumer of a pharmaceutical for erectile dysfunction treatment.

Traditional methods of marketing and promotion for pharmaceutical companies and retail pharmacies require merchants to make promotional announcements through media outlets. Typical media outlets include television, radio, newspapers and magazines. However, the marketing and promotion of a pharmaceutical product through traditional media outlets has several limitations that militate against educating the consumer in the manner required to achieve the desired loyalty. First, it is very expensive to design and maintain a media advertising campaign. Second, media promotion does not lend itself to ongoing consumer education and support without the purchase and production of additional and costly commercial spots. Third, and particularly important to the present invention, the sensitive nature of the treatment and the patients individual concerns are not suitable to be entirely resolved in a mass marketing program.

An alternative method of marketing is by a direct mailing to the consumer, which may provide, among other items, redeemable coupons. However, the management of coupon verification, coupon handling and redemption are inefficient and burdensome for the merchant and others. Merchants must collect coupons as they are presented, verify that the presented coupons are valid, and then honor the discounts. Coupons issued by companies or other third parties are compiled and then sent to their respective issuers for redemption. In this latter case, merchants have the disadvantage of having to wait to receive full payment from the manufacturer or third-party-coupon issuer for the goods that were sold earlier at a discount. Reimbursement can take weeks, even months. Such delays have a detrimental effect on a merchant's cash flow and places an undesirable accounts management burden on the merchant.

Moreover, and with particular relevance to the present invention, the requirements of the Health Insurance Portability and Accountability Act of 1996 (HIPAA) restrict the promotion of prescription pharmaceuticals. Thus, many traditional promotion techniques, in particular direct marketing without a prior relationship with the patient or consumer, may be illegal.

Several prescription benefit programs exist in the art. However, none of the current programs provide a means for effectively educating the consumer, promoting consumer loyalty and rewarding such consumer loyalty.

U.S. Patent Application Publication No. 2004/0073457 to Kalies (“Kalies”) is directed to a method for conducting prescription drug co-payment plans. Specifically, Kalies discloses a 100% co-pay program that requires adjudication of each prescription wherein payment, less a predetermined co-payment tendered by the patient, is issued to the participating pharmacy by a prescription benefits manager (PBM). To properly adjudicate the prescription, the PBM maintains an eligibility file for each subscriber containing, in part, the subscriber's current credit card information. Once the claim is approved by the PBM, the proper discounted price is determined and patient advocacy issues are resolved. The PBM then directs the pharmacy to fill the prescription with instructions as to what portion of the prescription price it is to collect from the subscriber, typically a co-payment of $5-$10. The remaining portion of the prescription charges is billed to the credit card account listed in the subscriber's eligibility file. Thus, while the Kalies plan still requires a 100% co-pay by the uninsured subscriber, a significant portion of the pharmacy's compensation is provided through the PBM, providing an incentive for the pharmacy to adjudicate the subscriber's prescription claims with the PBM to assure that the subscriber receives the appropriate discount and patient advocacy.

Kalies does not disclose means for tracking a patient's prescription medication purchasing loyalty over time. Kalies also does not disclose a pre-specified loyalty rewards benefit in the form of a free prescription after a predetermined number of tracked prescription medication purchases.

U.S. Patent Application Publication No. 2002/0002495 to Ullman (“Ullman”) is directed to a system and method for integrated pharmaceutical accounts management. The Ullman system purports to provide an integrated suite of services for consumers, service providers, and manufacturers by utilizing instant adjudication of prescription, consumer data warehousing, and incentive rewards for the consumer. A participating consumer with one card can instantly purchase pharmaceuticals, charge the transaction to a credit card, and earn and apply saving dollars redeemable for pharmaceutical purchases. The Ullman system contemplates that a participating consumer can accumulate rewards (i.e., cash rebates) as a variable percentage of certain qualified purchases.

Ullman does not disclose a system wherein pharmacies provide loyalty rewards directly to the consumer of a specific pharmaceutical, in direct cooperation with the specific pharmaceutical manufacturer. Ullman does not disclose a means for tracking a patient's prescription purchasing loyalty over time, in order to provide a pre-specified benefit in the form of a free prescription after a predetermined number of such purchases.

U.S. Patent Application Publication No. 2003/0050799 to Jay (“Jay”) is directed to permission based marketing for use with medical prescriptions. Jay contemplates that, as patient information is increasingly being stored in electronic form, patient privacy has become an important issue. On the other hand, organizations that provide medical products or services desire to readily reach patients with particular medical profiles, and to provide relevant product advertisement, price discounts, or clinical study enrollment to patients with particular profiles.

Jay does not disclose pharmacies providing discounts and rebates on a specific pharmaceutical, in cooperation with the specific pharmaceutical manufacturer. Jay is specifically designed for use by physicians and insurance companies in contradistinction to patients and pharmaceutical manufacturers. Jay does not disclose tracking purchases of a specific pharmaceutical by a specific patient over time specifically to provide discounts or rebates or free prescriptions after a predetermined number of such purchases.

U.S. Patent Application Publication No. 2004/0064368 to Koser (“Koser”) is directed to a system and method for providing customer-specific marketing, discounts, and promotions. The Koser system includes a point-of-service device (e.g., a cash register), a customer interface device, one or more local promotional servers, and a central promotional server.

Koser describes a system for use in a multiple store retail chain, wherein the system is adapted to operate in conjunction with the retail chain's customer loyalty program. The retail chain itself devises the customer loyalty program, and each customer participating in the customer loyalty program is assigned a loyalty program identifier by the retail chain. The customer's loyalty program identifier is transmitted from the customer interface device to the local promotional server. Software running on the local promotional server is operable to recognize the customer based on the customer's loyalty program identifier. If information about the customer is stored on the local promotional server, the software running on the local promotional server recognizes the customer based on this information. After the customer is recognized, the software running on the local promotional server identifies any promotions for which the customer is eligible. Such promotions have been prepared in advance and stored on the local promotional server.

Koser does not disclose pharmacies providing discounts and rebates on a specific pharmaceutical purchase in direct cooperation with the specific pharmaceutical manufacturer. Koser is unrelated to a specific pharmaceutical and to a specific pharmaceutical manufacturer devised consumer loyalty program. Koser further fails to disclose and is unrelated to a managed care adjudication system or track and record patients' purchasing information as to a specific pharmaceutical.

A need exists in the art for a practical system for providing product information for and to a specific individual and consumer of a specific pharmaceutical. A need also exists for a system and method wherein pharmacies provide discounts and rebates on a specific pharmaceutical in direct cooperation with the specific pharmaceutical manufacturer. A need additionally exists for a means for readily tracking an individual's purchasing loyalty for a specific prescribed pharmaceutical, in order to provide a pre-specified benefit in the form of a free prescription after a predetermined number of such specific pharmaceutical purchases. There a further need to ensure that patients seeking a free prescription are in fact entitled to that prescription and are not attempting to commit fraud or abuse the benefit by, for example, seeking a free prescription when they are being reimbursed by a third party.

The erectile dysfunction treatment art desires a system to minimize the discontinuance of medication and reward loyal consumers for their continued purchase of the medication.

### SUMMARY OF THE INVENTION

It is an object of the present invention to provide a system and method for educating a pharmaceutical consumer.

It is another object of the present invention to provide a system and method for educating a pharmaceutical consumer of an erectile dysfunction treatment.

It is still another object of the present invention to provide a means for rewarding pharmaceutical consumer loyalty.

It is yet another object of the present invention to provide a means for rewarding the loyalty of a pharmaceutical consumer of an erectile dysfunction treatment.

It is a further object of the present invention to provide a system and method for educating a pharmaceutical consumer including enrolling the consumer in a rewards program and tracking the consumer's purchasing activity.

It is a still further object of the present invention to provide a system and method for educating a pharmaceutical consumer of an erectile dysfunction treatment including enrolling the consumer in a rewards program and tracking the consumer's purchasing activity.

It is an additional object of the present invention to provide a means for rewarding a consumer of a specific prescription pharmaceutical with a free prescription after a prescribed number of prescriptions are filled and paid for without reimbursement by a third party.

It is a further object of the present invention to provide a means for rewarding a consumer of an erectile dysfunction treatment with a free prescription after a prescribed number of prescriptions for the erectile dysfunction treatment are filled and paid for without reimbursement by a third party.

These and other objects and advantages are achieved by the present system and method for educating and rewarding a consumer of a prescribed pharmaceutical or intervention. The present system includes a means for enrolling the consumer in a consumer loyalty rewards program, a means for providing the consumer with information relating to the intervention, a means for tracking purchases of the intervention by the consumer, and a means for providing the consumer with a loyalty reward.

The present invention further provides a method for rewarding a consumer for loyalty in the purchase of a specific intervention. The method includes the steps of enrolling the consumer in a consumer loyalty rewards program, providing the consumer with information relating to the intervention, tracking the consumer's purchases of the intervention, issuing a reward after a prescribed number of purchases.

The foregoing and still other objects and advantages of the present invention will be more apparent from the following detailed explanation of the preferred embodiments in connection with the accompanying drawings.

### BRIEF DESCRIPTION OF THE DRAWINGS

FIG. 1 is a general schematic diagram of the parties in accordance with the consumer education and loyalty reward system and method of the present invention.

FIG. 2 is a flowchart of a transaction in accordance with the consumer education and loyalty reward system and method of the present invention.

FIG. 3 is a flowchart depicting the enrollment process in accordance with the consumer education and loyalty reward system and method of the present invention.

FIG. 4 is a flowchart depicting a direct mail campaign in accordance with the consumer education and loyalty reward system and method of the present invention.

FIG. 5 is a flowchart depicting an in-pharmacy campaign in accordance with the consumer education and loyalty reward system and method of the present invention.

FIG. 6 is a flowchart of an exemplary media campaign in accordance with the consumer education and loyalty reward system and method of the present invention.

FIG. 7 is a flowchart of an exemplary direct email campaign in accordance with the consumer education and loyalty reward system and method of the present invention.

FIG. 8 is a flowchart depicting the process of consumer education in accordance with an alternate embodiment of the consumer education and loyalty reward system and method of the present invention.

### DETAILED DESCRIPTION OF THE INVENTION

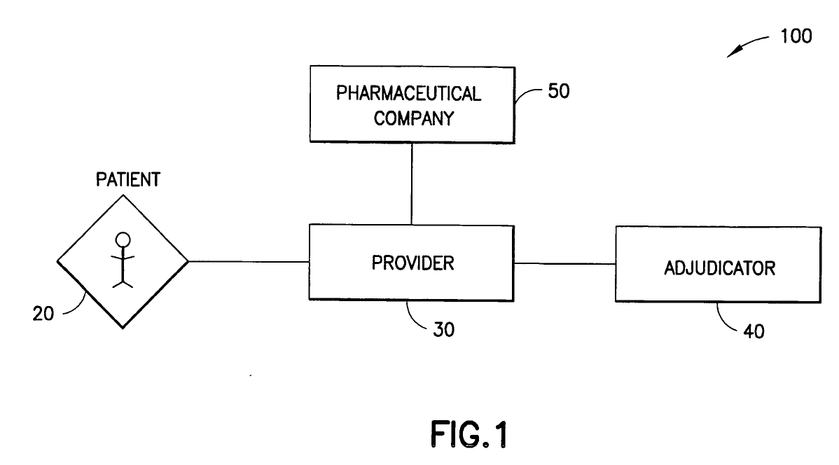

Referring to the Figs. and, in particular, to FIG. 1, there is illustrated a consumer education and loyalty reward system and method generally represented by reference numeral 100. The primary parties involved in education and reward system 100 include a patient/subscriber or consumer 20, a service provider 30, a prescription benefits manager or adjudicator 40 and a pharmaceutical company or program administrator 50.

A service or product provider is an entity that provides healthcare services or products. In the case of pharmaceutical products and services, such providers include independent pharmacies, drug store chains, supermarket combinations (pharmacies inside supermarkets), mass volume retailers, mail order and Internet pharmacies and prescription fulfillment companies.

An adjudicator is an entity that provides on-line claim adjudication services to such service and product providers. Specifically, an adjudicator adjudicates claims of a consumer who has prescription drug benefits. An adjudicator typically enters into an agreement with a provider to supply software packages for such purposes as automated imputing and formatting of electronic claims. Although the performance of competing software systems vary dramatically, the functions they perform and the formats used to transmit third-party pharmacy claims are essentially identical because all electronic messages must conform to one or more of the standard electronic message formats set by the National Council for Prescription Drug Programs (“NCPDP”) of Phoenix, Ariz.

Consumer education and loyalty reward system 100 is intended to provide consumer 20 with the information necessary to continue a prescribed course of therapy. To this end, consumer education and loyalty reward system 100 provides a means for pharmaceutical company 40 to communicate educational information to consumer 20 regarding a prescribed pharmaceutical or intervention or intervention. Consumer education and loyalty reward system 100 additionally promotes customer loyalty by providing a loyalty reward to consumer 20. In one preferred embodiment, the reward is the provision of a prescription at no charge to consumer 20 after a prescribed number of prescriptions have been purchased by consumer 20. The combination of consumer education and reward is intended to provide the desired support to consumer 20 to enable and encourage him to continue his prescribed course of treatment.

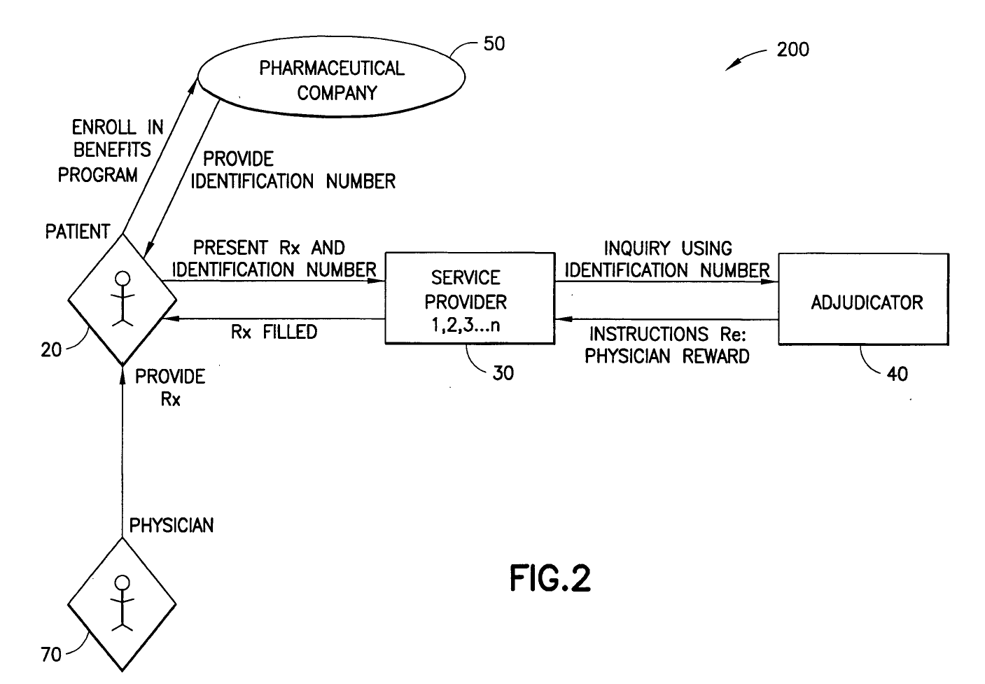

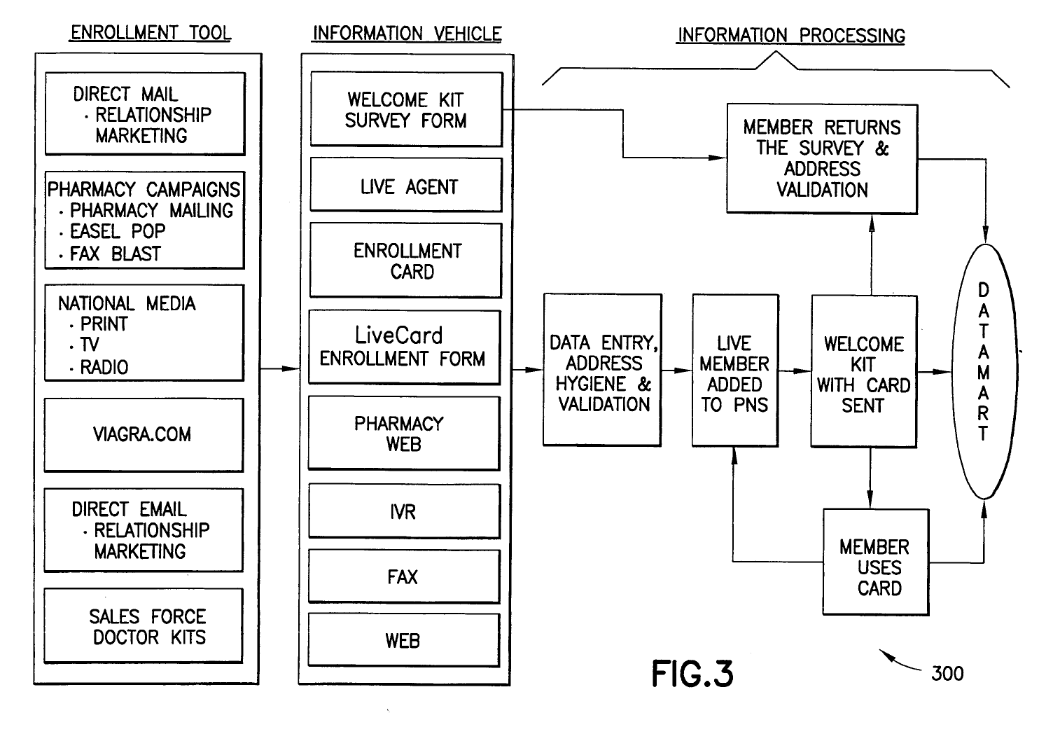

Referring to FIGS. 2 and 3, consumer education and loyalty reward system 100 includes a means for enrolling consumer 20 in a loyalty rewards program, a means for providing consumer 20 with information regarding the prescribed pharmaceutical or intervention or intervention, a means for tracking the purchase of said prescribed pharmaceutical or intervention or intervention by consumer 20, and a means for rewarding consumer 20 with a loyalty reward.

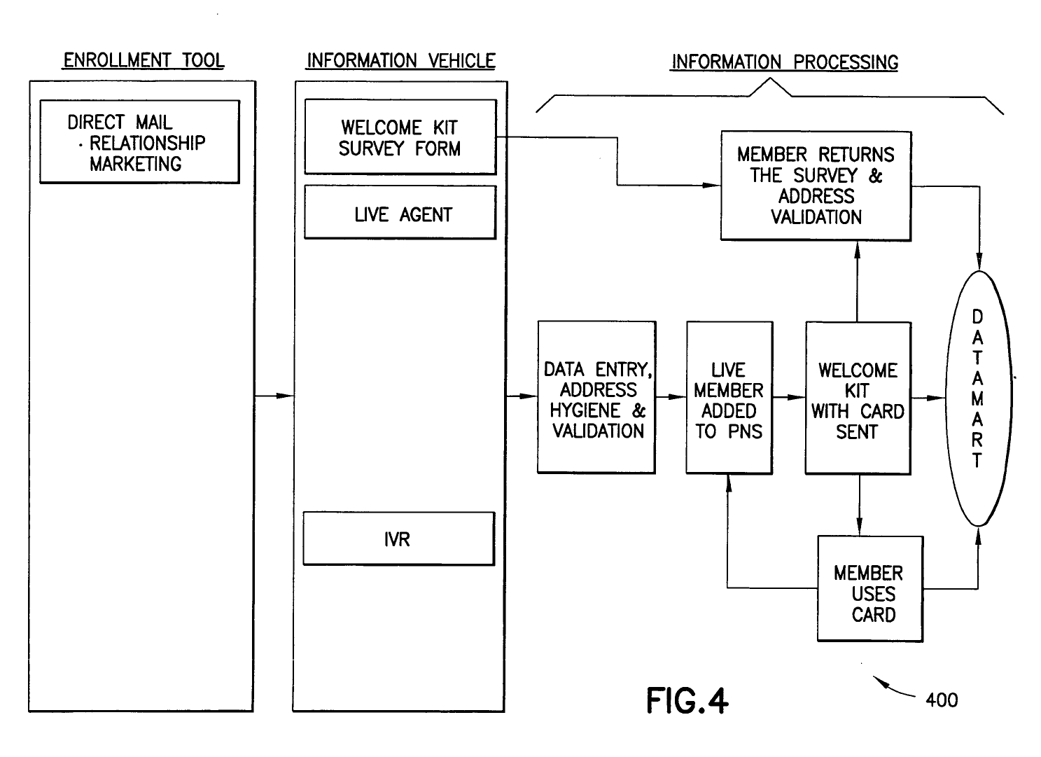

Consumer education and loyalty reward system 100 provides a means for enrolling consumer 20 in a consumer loyalty rewards program. Consent is required to comply with the Health Insurance Portability and Accountability Act of 1996. Enrollment is required for pharmaceutical company 50 to track the purchases of a specific pharmaceutical or intervention and, thus, to provide a reward after a prescribed number of purchases. Enrollment requires that consumer 20 consent to participation in consumer education and loyalty reward system 100 provided by pharmaceutical company 50. Specifically, consumer 20 must consent to enrollment in the program in order to receive information from pharmaceutical company 50, and to allow pharmaceutical company 50 to track the number of prescriptions of a prescribed pharmaceutical that are filled and also the amount of tablets dispensed in each filled prescription. Enrollment further requires that consumer 20 provide personal information such as contact information. This information allows pharmaceutical company 50 to contact consumer 20 by direct mail, telephone, email, or any other suitable means to provide product information and updates, as best shown in FIG. 4.

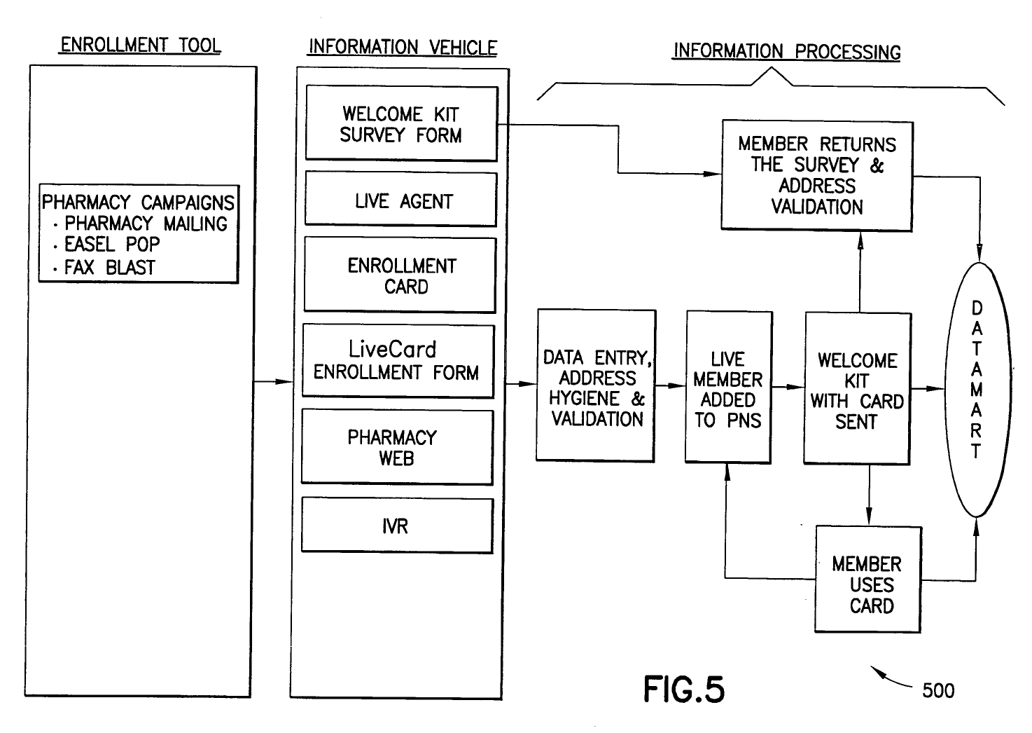

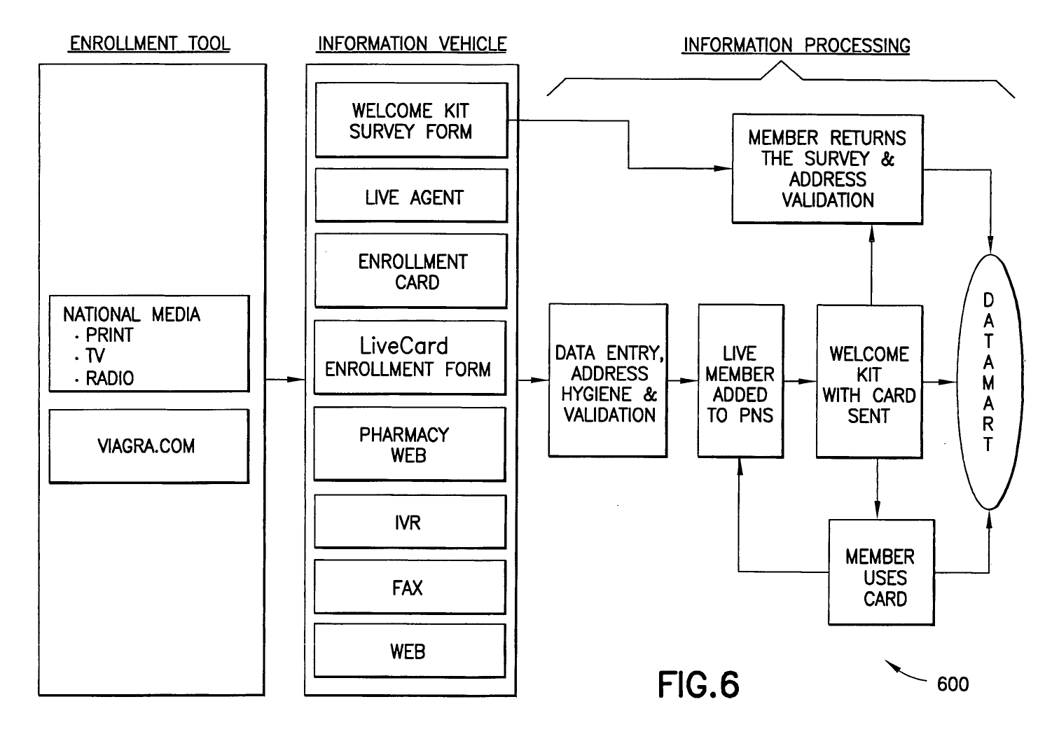

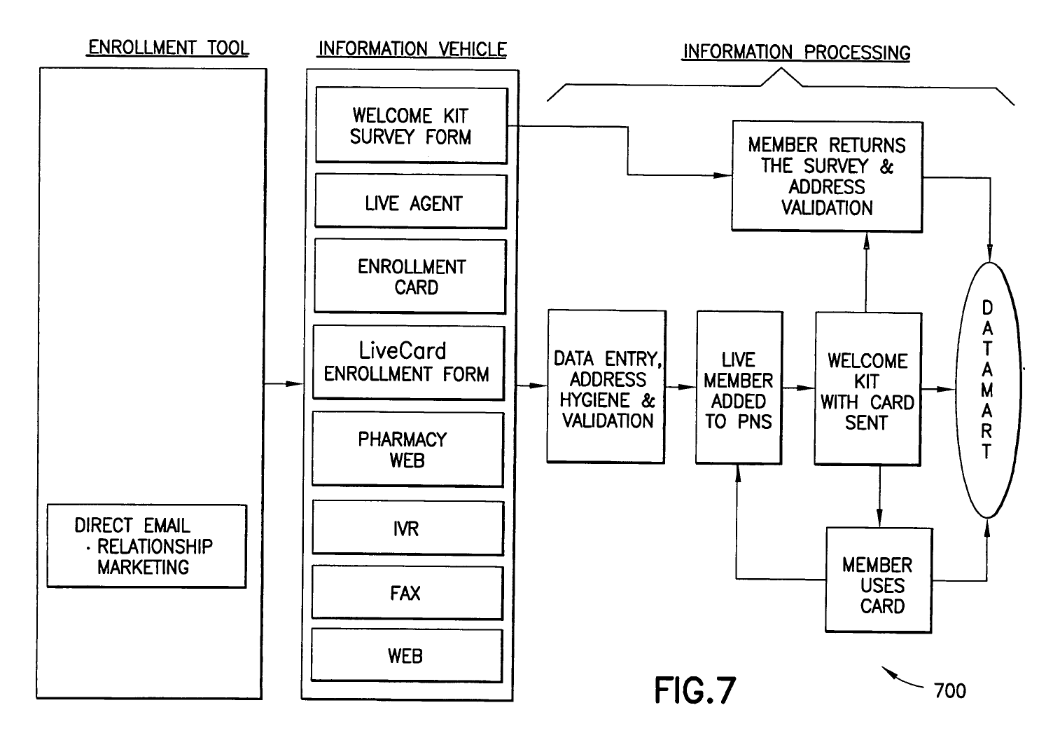

Referring specifically to FIGS. 5 to 7, enrollment may be accomplished by means known in the art particularly including completing an application at service provider 30, where the pharmaceutical or intervention is dispensed, at the office of the doctor prescribing the pharmaceutical, via telephone, or the Internet.

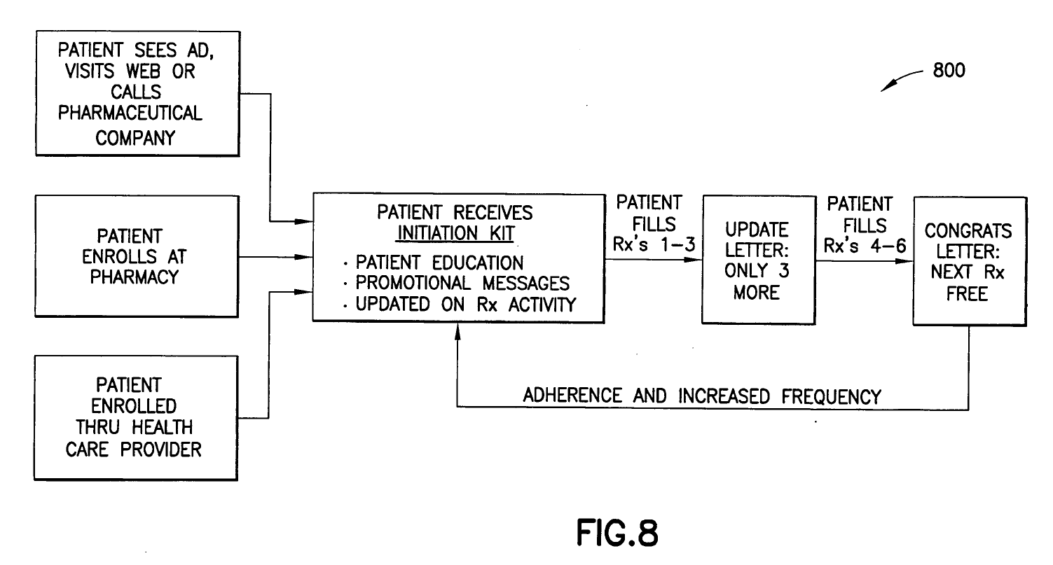

Referring specifically to FIG. 8, consumer education and loyalty reward system 100 also provides a means for providing consumer 20 with information regarding the prescribed pharmaceutical or intervention. Information may be communicated to consumer 20 via email, telephone, direct mail, by the physician, by the pharmacist, or by any means known in the art. The information provided may include, but is not limited to, information to optimize treatment using the prescribed pharmaceutical or intervention, ensure the consumer's partner is engaged in the treatment program, initiate a discussion with a physician, and ensure proper dosage to avoid potential adverse side effects.

In one preferred embodiment, consumer 20 receives a promotional package upon enrollment, followed by a series of informational brochures or newsletters. Customer 20 additionally receives a letter informing him when he is near to earning his reward.

Consumer education and loyalty reward system 100 additionally provides a means for tracking the purchase of the prescribed pharmaceutical or intervention or intervention by consumer 20. Provider 30, in order to participate in the consumer education and rewards program 100, must subscribe to an adjudication system managed by adjudicator 40. Non-limiting examples of suitable adjudicators include a managed care organization or a prescription benefits manager. One preferred adjudication system is that of Argus Health Systems, Inc. of Kansas City, Mo. (“Argus”). Argus is the preferred adjudicator of a large majority of U.S. pharmacies. Accordingly, subscription to the Argus adjudication system enables consumer 20 to fill prescriptions at a large number of service providers 30. Another adjudication system that may be used with the present invention is that of Caremark, Inc. of San Antonio, Tex. However, it should be noted that any adjudication system with a nation-wide network may be employed.

Consumer education and loyalty reward system 100 further provides a means for rewarding consumer 20 with a loyalty reward. In a preferred embodiment, consumer education and loyalty reward system 100 provides consumer 20 with a free prescription after a prescribed number of purchases of the prescribed pharmaceutical or intervention. Financial incentive is believed to be an effective means to further encourage a pharmaceutical consumer to continue a course of treatment.

The present invention provides that patients purchasing the prescribed pharmaceutical or intervention are eligible to receive a free prescription after purchasing a prescribed number of full-price prescriptions. In a most preferred embodiment, the seventh prescription is free to consumer 20, and paid for by provider 30. Pharmaceutical company 50 subsequently reimburses provider 30 for the dispensed prescription.

The present invention further provides that consumer education and loyalty reward system 100 is a rolling system wherein every seventh prescription will be filled at no charge to consumer 20. The benefit continues as long as pharmaceutical company 50 continues to sponsor consumer education and loyalty reward system 100.

Referring again to FIG. 2, a flowchart of a typical transaction in accordance with the principles of the present invention is presented. To commence implementation of consumer education and loyalty reward system 100, consumer 20 first receives a prescription from a physician or other prescriber 70. Consumer 20 must then complete an enrollment process with pharmaceutical company 50.

Upon enrollment, consumer 20 is preferably provided an identification number and a temporary identification card by pharmaceutical company 50. The identification number reflects an account which allows service provider 30 to track the purchasing activity of consumer 20 through the assistance of adjudicator 40. Specifically, the identification number allows adjudicator 40 to track the number of eligible pharmaceutical prescriptions that have been filled and purchased by consumer 20, and to communicate that information electronically to service provider 30. Preferably, the temporary identification card may be used only once. The temporary identification card enables consumer 20 to get program credit for his first prescription purchase. Consumer 20 must request a permanent card from pharmaceutical company 50 via the Internet, telephone, or any other comparable means in order to complete enrollment in consumer education and loyalty reward system 100.

Consumer 20 then presents both his prescription and his identification card reflecting his identification number to a participating service provider 30. Provider 30 communicates the identification number to adjudicator 40 via electronic means for telecommunication. Adjudicator 40 provides information relating to the account of consumer 20 to service provider 30.

Adjudicator 40 preferably performs several verification functions. First, adjudicator 40 verifies the identity of consumer 20 using the assigned consumer identification number. Second, the administrator verifies that consumer 20 is conforming to the rules or components of consumer education and loyalty reward system 100. A non-limiting example of a system component is that each prescription filled must comprise a certain number of tablets. Preferably, the minimum number of tablets for a qualifying prescription purchase is two. An additional example of a system component is verification that consumer 20 has not received reimbursement from a third party insurance company for the purchase of the prescription. A further example of a system component is that only the number of tablets not partially or alternately fully covered by insurance reimbursement is counted towards the reward. Third, adjudicator 40 tracks the purchasing activity of consumer 20 for the prescribed pharmaceutical or intervention. At the appropriate time, adjudicator 40 communicates to service provider 30 that a prescribed number of pharmaceutical purchases have been made and that the present prescription is to be filled at no charge to consumer 20.

Provider 30 then fills the prescription for consumer 20 free of charge. Provider 30 then seeks reimbursement from pharmaceutical company 50 for the dispensed prescription. Provider 30 is preferably reimbursed by pharmaceutical company 50 for the cost of dispensing the pharmaceutical or intervention in addition to a dispensing fee.

The present invention has been described with particular reference to certain preferred embodiments. It should be understood that the foregoing description and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. A system for educating and rewarding a consumer of an intervention for a disease or disorder, the system comprising:
means for enrolling the consumer in a consumer loyalty rewards program;
means for providing the consumer with information relating to the intervention;
means for tracking purchases of the intervention by the consumer; and
means for providing the consumer with a consumer loyalty reward.

2. The system of claim 1, wherein the disorder comprises erectile dysfunction.

3. The system of claim 1, wherein said loyalty reward comprises one said intervention free of charge to the consumer after a prescribed number of said purchases.

4. The system of claim 3, wherein the intervention comprises a pharmaceutical and said pharmaceutical comprises sildenafil citrate.

5. The system of claim 1, wherein said disorder is not a life-threatening disorder, but produces an adverse psychological effect.

6. The system of claim 5, wherein said intervention assuages the psychological effect.

7. The system of claim 1, wherein the intervention comprises a pharmaceutical prescribed by a physician, and the reward comprises a free prescription for the prescribed pharmaceutical.

8. The system of claim 1, wherein said means for enrolling comprises one means selected from the group consisting of on-line enrollment, enrollment at a provider, enrollment through the mail, and enrollment at a physician's office.

9. The system of claim 8, wherein said enrollment must be confirmed with the pharmaceutical company.

10. The system of claim 9, wherein the enrollment may confirmed by telephone or the Internet.

11. The system of claim 1, wherein the intervention comprises a pharmaceutical, and the information is provided to the consumer by the pharmaceutical manufacturer by at least one means selected from the group consisting of direct mail, brochure distributed by a service provider, brochure distributed by a physician, and telemarketing.

12. The system of claim 1, wherein the intervention comprises a pharmaceutical, and the information comprises educational information regarding the pharmaceutical comprising use and management of the pharmaceutical.

13. The system of claim 1, wherein the means for tracking comprises an adjudication system.

14. The system of claim 13, wherein the adjudication system comprises means for verifying that the consumer has purchased a prescribed minimum number of said pharmaceutical.

15. The system of claim 13, wherein the adjudication system verifies that the consumer receives a certain reimbursement for the purchase of the pharmaceutical.

16. The system of claim 13, wherein the adjudication system verifies that a purchase of the intervention comprises at least two units.

17. The system of claim 13, wherein the adjudication system verifies that the free prescription comprises a total unit count about equal to the average unit count of the previous purchases.

18. The system of claim 13, wherein the adjudication system is administered by a managed care organization.

19. The system of claim 13, wherein the adjudication system is administered by a pharmacy benefit manager.

20. The system of claim 1, wherein the adjudication system is administered by a nation-wide system.

21. The system of claim 13, wherein the intervention is purchased from a product provider.

22. The system of claim 20, wherein the provider subscribes to the adjudicating system.

23. The system of claim 1, wherein the reward is issued when the purchases comprise a prescribed number of purchases.

24. The system of claim 23, wherein the prescribed number of purchases comprises six.

25. The system of claim 1, wherein the intervention comprises a prescribed pharmaceutical and the disorder comprises erectile dysfunction.

26. The system of claim 21, wherein the provider provides the reward in direct cooperation with a pharmaceutical company.

27. The system of claim 1, wherein the reward further comprises a discount or rebate on future purchases of the intervention.

28. The system of claim 1, wherein the means for tracking the purchases comprises means for issuing an enrollment card to the consumer for said tracking.

29. The system of claim 23, wherein the reward program comprises means for renewal.

30. A method for rewarding a consumer for loyalty in the purchase of an intervention for a disease or disorder, said method comprising:
enrolling the consumer in a consumer loyalty rewards program;
providing the consumer with information relating to the intervention;
tracking the consumer's purchases of the intervention; and
issuing a reward after a prescribed number of said purchases.

31. The method of claim 30, further comprising redeeming the reward at a provider of the intervention.

32. The method of claim 30, wherein the intervention comprises a pharmaceutical prescribed by a physician.

33. The method of claim 30, wherein the disorder is erectile dysfunction.

34. The method of claim 33, wherein the intervention comprises a pharmaceutical and the pharmaceutical comprises sildenfil citrate.

35. The method of claim 30, further comprising excluding third party reimbursed purchasing of the intervention.
